(19) United States
(12) Patent Application Publication
(10) Pub. No.: US 2026/0295976 A1
(43) Pub. Date: Oct. 1, 2026

(54) DEVICE AND METHOD FOR PREVENTING ADHESIVE PEEL ON CONVEXLY CURVED GLASS ARTICLES

(71) Applicant: CORNING INCORPORATED, CORNING, NY (US)

(72) Inventors: Jordon Thomas Boggs, Middlebury Center, PA (US); Jason Scott Stewart, Hornell, NY (US); Arlin Lee Weikel, Mansfield, PA (US)

(21) Appl. No.: 19/476,959

(22) PCT Filed: Apr. 3, 2024
(86) PCT No.: PCT/US2024/022793

§ 371 Date: Oct. 20, 2025

Related U.S. Application Data
(60) Provisional application No. 63/462,024, filed on Apr. 26, 2023.

(51) Int. Cl. B32B 17/10; B32B 7/08; B32B 7/12; B60R 13/02

(52) U.S. Cl. CPC B32B 17/10036; B32B 7/08; B32B 7/12; B32B 2307/54; B32B 2307/7376; B32B 2605/00; B60R 13/0256; B60R 13/0262; B60R 2013/0287

(57) ABSTRACT

A glass article includes a frame having a curved frame surface and a rear frame surface. The curved frame surface defines at least one convex curvature. The glass article also includes a glass substrate having a first major surface, a second major surface, a first end, and a second end. A first adhesive attaches the second major surface of the glass substrate to the curved frame surface such that the glass substrate is elastically deformed and the first major surface defines a convex curvature. A first anchor has a first portion attached to the second major surface of the glass substrate and a second portion abutted against the rear frame surface. The frame and first anchor are configured such that the first anchor is able to move laterally and such that the first anchor is constrained against movement in a direction perpendicular to the second major surface.

### CROSS-REFERENCE TO RELATED APPLICATIONS

This application claims the benefit of priority of U.S. Provisional Application Ser. No. 63/462,024, filed on Apr. 26, 2023, the content of which is relied upon and incorporated herein by reference in its entirety.

### BACKGROUND

The disclosure relates to glass articles for vehicle interior components and, more particularly, to glass articles having one or more anchors configured to control movement of a glass substrate relative to a frame.

Vehicle interiors include curved surfaces and can incorporate displays in such curved surfaces. The materials used to form such curved surfaces are typically limited to polymers, which do not exhibit the durability and optical performance as glass. As such, curved glass substrates are desirable, especially when used as covers for displays. Existing methods of forming such curved glass substrates, such as thermal forming, have drawbacks including high cost, optical distortion, and surface marking. Accordingly, Applicant has identified a need for vehicle interior components that can incorporate a curved glass substrate in a cost-effective manner and without problems typically associated with glass thermal forming processes.

### SUMMARY

According to an aspect, embodiments of the disclosure relate to a glass article. The glass article includes a frame having a curved frame surface and a rear frame surface. The curved frame surface defines at least one convex curvature, and the rear frame surface is opposite to the curved frame surface. The glass article also includes a glass substrate having a first major surface, a second major surface opposite to the first major surface, a first end, and a second end. A first adhesive attaches the second major surface of the glass substrate to the curved frame surface such that the glass substrate is elastically deformed and the first major surface defines a convex curvature between the first end and the second end. A first anchor has a first portion attached to the second major surface of the glass substrate and a second portion abutted against the rear frame surface. The frame and first anchor are configured such that the first anchor is able to move laterally in the direction of the first end or the second end and such that the first anchor is constrained against movement in a direction perpendicular to the second major surface.

According to another aspect, embodiments of the disclosure relate to a method. In the method, a glass substrate is elastically bent over a forming surface at a temperature of less than 200° C. The glass substrate includes a first major surface, a second major surface opposite to the first major surface, a first end, and a second end. The second major surface of the glass substrate is adhered to a frame using a first adhesive. A first portion of a first anchor is attached to the second major surface of the glass substrate. A second portion of the first anchor is abutted against the frame such that the first anchor prevents movement of the second major surface away from the frame. After the abutting, the first anchor is configured to move with at least one degree of freedom relative to the frame in response to thermal dimensional changes of at least one of the frame and the glass substrate.

According to still another aspect, embodiments of the disclosure relate to a glass article. The glass article includes a frame having a convexly curved surface. The glass article also includes a cold-formed glass substrate adhered to the convexly curved surface. At least one anchor is attached to the cold-formed glass substrate. The at least one anchor engages the frame in such a way as to constrain the cold-formed glass substrate from motion in a direction away from the convexly curved surface.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a vehicle interior with vehicle interior systems having convexly curved glass articles, according to exemplary embodiments;

FIG. 2 is side view of a convexly curved glass article, according to an exemplary embodiment;

FIG. 3 is a cross-sectional view of the convexly curved glass article of FIG. 2 taken along line A-A of FIG. 2, according to an exemplary embodiment;

FIG. 4 is a detailed view of a portion of the convexly curved glass article shown in FIG. 3, according to an exemplary embodiment;

FIG. 5 is a schematic depiction of positions of anchors used in attaching a glass substrate to a frame, according to an exemplary embodiment;

FIG. 6 is a schematic depiction of a slot in a frame accommodating multiple anchors, according to an exemplary embodiment;

FIG. 7 is a flow diagram of a method for forming a convexly curved glass article, according to an exemplary embodiment; and

FIG. 8 depicts a glass substrate usable for forming the convexly curved glass article, according to an exemplary embodiment.

### DETAILED DESCRIPTION

Reference will now be made in detail to various embodiments of a glass article for a vehicle interior system in which a glass substrate is cold-formed to a convex curvature and secured to a frame using a plurality of anchors. Glass articles of vehicle interiors are subject to a wide range of temperatures, and the glass substrate and frame may thermally expand and contract at different rates, leading to the development of stresses in the adhesive layer joining them. Cold-formed and convexly curved glass substrates already place high tensile stresses on the adhesive layer because the adhesive must hold the glass substrate against elastic recovery to an initial (e.g., planar) configuration. In certain circumstances, the combination of thermally induced stresses and the tensile stresses associated with cold-forming can overcome the strength of the adhesive layer, causing the glass substrate to peel from the frame.

According to the present disclosure, the glass substrate is restrained in a direction perpendicular to a major surface of the glass substrate by one or more anchors to prevent the glass substrate from peeling from the frame. Further, the anchor engages the frame in such a way as to still provide relative lateral movement of the glass substrate and frame to account for the different thermal expansion and contraction of the glass substrate and frame. That is, the anchor is attached to the glass substrate in such a way that the anchor can move with at least one degree of freedom relative to the frame in response to thermally-induced dimensional changes in the glass substrate and the frame. Allowing movement between the anchor and the frame beneficially reduces stresses on the glass substrate and promotes durability of a connection between the glass substrate and frame. These and other aspects and advantages of the glass article will be described in relation to the embodiments provide below and depicted in the figures. These embodiments are presented by way of illustration and not by way of limitation.

In general, a vehicle interior or exterior may include a variety of different curved surfaces, such as display surfaces or architectural surfaces. Covering such vehicle surfaces with a glass material provides a number of advantages compared to the typical curved plastic panels that are conventionally found in vehicle interiors. For example, glass is typically considered to provide enhanced functionality and user experience in many cover material applications, such as display applications and touch screen applications, compared to plastic cover materials.

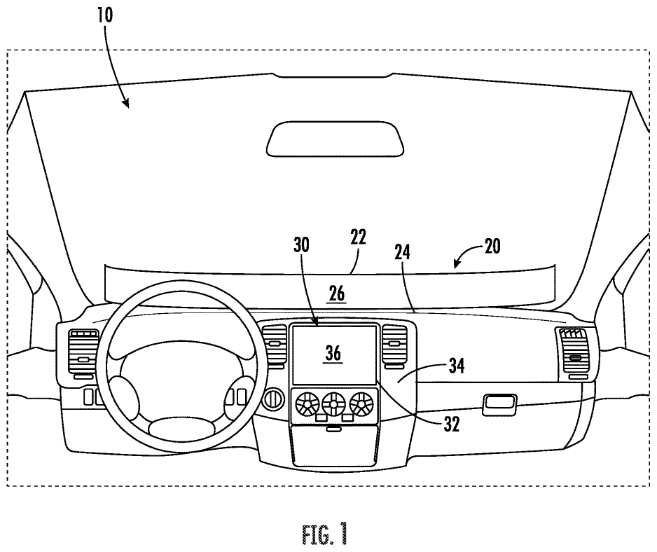

FIG. 1 shows an exemplary vehicle 10 that includes two different embodiments of vehicle interior components 20, 30. In the embodiment depicted, vehicle interior component 20 includes a display 22 mounted on a dashboard 24 of the vehicle 10. The display 22 includes a convexly curved surface 26. Further, in the embodiment depicted, vehicle interior component 30 is a display 32 mounted in a center console 34 of the vehicle 10. The display 32 includes a convexly curved surface 36. In one or more embodiments, the vehicle includes a convexly curved surface mounted in an arm rest, a pillar, a seat back, a floorboard, a headrest, a door panel, or any portion of the interior of a vehicle that includes or could include a curved surface. While exemplary embodiments relate to vehicle interior components, the present disclosure is not so limited, and embodiments of the present disclosure may also relate to vehicle exterior components having convexly curved glass surfaces, such as the bonnet, trunk lid, windshield pillar, and trim elements, amongst other possibilities.

The embodiments of the convexly curved glass articles described herein can be used in each of vehicle interior components 20, 30, among others, as well as in vehicle exterior components. In some such embodiments, the glass article discussed herein may include a cover glass substrate that also covers display or non-display surfaces of the dashboard, center console, etc. In such embodiments, the glass material may be selected based on its weight, aesthetic appearance, etc. and may be provided with a coating (e.g., an ink or pigment coating) including a pattern (e.g., a brushed metal appearance, a wood grain appearance, a leather appearance, a color appearance, etc.) to visually match the glass components with adjacent non-glass components. In specific embodiments used with displays, such ink or pigment coating may have a transparency level that provides for deadfront or color matching functionality when the display 22, 32 is inactive. Further, while the vehicle of FIG. 1 is in the form of an automobile (e.g., car, truck, bus, and the like), the glass articles disclosed herein can be incorporated into other vehicles, such as trains, sea craft (boats, ships, submarines, and the like), aircraft (e.g., drones, airplanes, jets, helicopters and the like), and spacecraft.

FIG. 2 depicts a side view of a glass article 50 that can be used for a convexly curved surface 26, 36 of the vehicle interior components 20, 30 of the vehicle 10. The glass article 50 is comprised of a glass substrate 52 attached to a frame 54 using a first adhesive 56. The glass substrate 52 has a first major surface 58 and a second major surface 60. The second major surface 60 is opposite to the first major surface 58. A minor surface 62 connects the first major surface 58 to the second major surface 60. The first major surface 58 and the second major surface 60 define a thickness T of the glass substrate 52 therebetween. In embodiments, the thickness T of the glass substrate 52 is from 0.3 mm to 2 mm, in particular 0.5 mm to 1.1 mm. In a vehicle, the first major surface 58 faces the occupants of the vehicle.

In embodiments, the first major surface 58 and/or the second major surface 60 includes one or more surface treatments. Examples of surface treatments that may be applied to one or both of the first major surface 58 and second major surface 60 include at least one of an anti-glare coating, an anti-reflective coating, a coating providing touch functionality, a decorative (e.g., ink or pigment) coating, or an easy-to-clean coating. Additionally, in embodiments, a display module may be bonded to the second major surface 60 of the glass substrate 52 (e.g., the display module can be laminated to the second major surface 60 within an opening defined by the frame 54). Exemplary display modules include at least one of a light-emitting diode (LED) display, an organic LED (OLED) display, a micro-LED display, a liquid crystal display (LCD), or a plasma display.

The frame 54 includes a curved frame surface 64. According to the present disclosure, the curved frame surface 64 defines at least one convex curvature. In one or more embodiments, the convex curvature has a minimum radius of curvature of 200 mm to 10,000 mm, in particular 200 mm to 6000 mm. As shown in FIG. 2, the convex curvature extends from a first end 66 of the glass article 50 to a second end 68 of the glass article 50. However, in one or more embodiments, the convex curvature does not extend from end-to-end of a glass article 50 and only spans a portion of the distance between the ends 66, 68 of the glass article 50. Further, in one or more embodiments, the convex curvature is not centrally located between the first end 66 and the second end 68 (e.g., being located closer to the first end 66 or the second end 68), and in one or more embodiments, the frame 64 defines multiple curvatures, including at least one convex curvature.

For example, the frame 64 may be C-shaped as shown in FIG. 2 (convex curvature extending from the first end 66 to the second end 68), V-shaped (convex curvature between two flat regions), J-shaped (convex curvature positioned nearer one end 66 than the other end 68), S-shaped (convex curvature followed by a concave curvature), or U-shaped (a first convex curvature near the first end 66 and a second convex curvature near the second end 68), amongst other possibilities. Still further, in one or more embodiments and depending on the shape of the glass article 50, the frame 54 may include multiple directions of curvature. For example, the frame 54 may have an outline defining a rectangle (as shown in the figures), a T shape, an I shape, or an L shape, amongst other possibilities, and different portions of the frame 54 may curve in different directions.

The first adhesive 56 attaches the second major surface 60 of the glass substrate 52 to the curved frame surface 64. In particular, the glass substrate 52 is cold-formed to conform to the convex curvature of the curved frame surface 64, and the first adhesive 56 retains the glass substrate 52 against the frame 54 so that the glass substrate 52 remains elastically deformed against the frame 54. In one or more embodiments, the glass substrate 52 conforms to the convex curvature (or curvatures) of the frame 54 to within 10%, in particular within 5%, and most particularly within 2% of the radius of curvature of the curved frame surface 64. That is, if the curved frame surface 64 has a radius of curvature of X, the glass substrate 52 has a radius of curvature in a range from 0.9X to 1.1X (in particular 0.95X to 1.05X, and most particularly 0.98X to 1.02X) as measured at the first major surface 58.

Advantageously, cold-forming the glass substrate 52 allows for surface treatments to be applied to the glass substrate 52 while it is in a flat configuration, and cold-forming the glass substrate 52 does not disrupt or degrade the surface treatments. By contrast, hot-forming the glass substrate 52 (e.g., at or above the softening temperature of the glass) would degrade the surface treatments applied before forming, and applying the surface treatments after forming is more difficult because of the curvature of the glass substrate 52. Additionally, hot-forming can cause defects that lead to optical distortion of the glass substrate 52, and cold-forming does not introduce such defects to the glass substrate 52.

In one or more embodiments, the first adhesive 56 is selected such that it has the strength to retain the glass substrate 52 in the cold-formed configuration. However, the first adhesive 56 is also subject to shear stresses imparted during thermal expansion and contraction. In particular, vehicles are used in a variety of environments where temperatures can reach −40° C. or lower or 50° C. or higher. The glass material of the glass substrate 52 and the material (e.g., metal, plastic, or fiber composite) of the frame 54 may have different coefficients of thermal expansion, which means that the glass substrate 52 and frame 54 will expand and contract at different rates when exposed to temperature extremes. The different rates of thermal expansion cause the glass substrate 52 and the frame 54 to move laterally relative to each other. This creates shear stress in the first adhesive 56, and the first adhesive 56 is selected such that it has a shear strength sufficient to withstand the shear stresses. However, in certain circumstances, the combination of tensile stress for retaining the glass substrate 52 and the shear stress experienced during thermal expansion and contraction can be enough to overcome the strength of the first adhesive 56, specifically at the ends of the convex curvature where the tensile stresses are the highest for a convexly curved glass substrate 52 and in situations where the convex curvature is positioned proximate to one of the ends 66, 68 of the glass substrate 52.

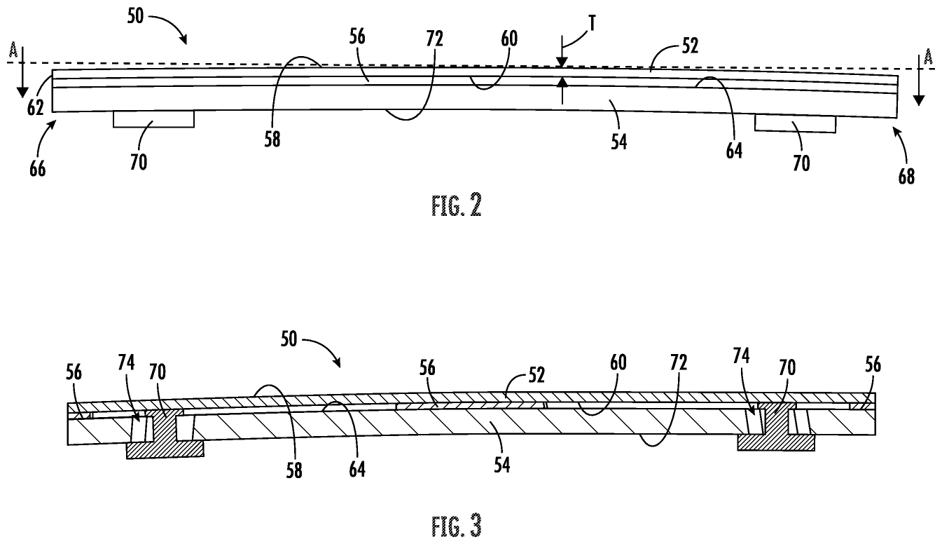

In order to avoid potential peeling of the glass substrate 52 from the frame 54, the glass article 50 is provided with one or more anchors 70. As shown in the cross-sectional view of FIG. 3, the anchors 70 are attached to the second major surface 60 of the glass substrate 52, and the anchors 70 extend through the frame 54. In particular, the frame 54 has a rear frame surface 72 opposite to the curved frame surface 64. In the embodiment shown in the figures, the frame 54 has a rear frame surface 72 having a curvature matching the curved frame surface 64; however, in one or more other embodiments, the frame 54 has a rear frame surface 72 that has a curvature that does not match or that opposes the curvature or the curved frame surface 64 or that is flat.

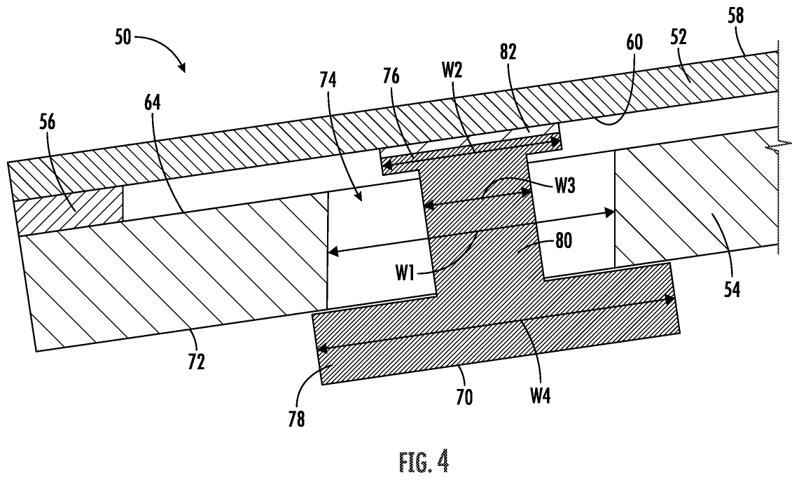

In one or more embodiments, the frame 54 includes one or more slots 74 that extend through the frame 64, e.g., extending from the curved frame surface 64 to the rear frame surface 72. Each anchor 70 is inserted through a slot 74 to attach the anchor 70 to the glass substrate 52. Referring now to FIG. 4, in one or more embodiments, each anchor 70 includes a first portion 76 attached to the glass substrate 52 and a second portion 78 that abuts the frame 54. In particular, the second portion 78 abuts the frame 54 without being joined or attached to the frame, such as through the use of an adhesive, bonding agent, or fastener. In this way, the second portion 78 of the anchor 70 is able to translate over the rear frame surface 72 while remaining in contact with the rear frame surface 72.

In one or more embodiments, the anchor 70 is formed from a plastic or composite material. For example, the anchor 70 is formed from a plastic, such as a polycarbonate, an acrylonitrile butadiene styrene, a polypropylene, a polyamide, a polyethylene, or blends of two or more thereof. In embodiments, the plastic may be filled with a reinforcing material, such as glass or carbon fiber, to provide a composite material.

In one or more embodiments, the first portion 76 of the anchor 70 is joined to the second portion 78 by an intermediate portion 80. The first portion 76 and the intermediate portion 80 are sized to be inserted through the slot 74, but the second portion 78 is sized such that it cannot pass through the slot 74. In this way, after the frame 54 is joined to the glass substrate 52, the first portion 76 and intermediate portion 80 can be inserted through the slot for attachment of the first portion 76 to the glass substrate 52, and the second portion 78 abuts the frame 54. In embodiments. the length of the intermediate portion 80 may be greater than a thickness of the frame 54 measured between the curved frame surface 64 and the rear frame surface 72 (in a direction perpendicular to the rear frame surface 72) by an amount that is less than or equal to a thickness of the first adhesive 54 to facilitate the second portion 78 contacting the rear frame surface 72 after the anchor 70 is attached to the glass substrate 52.

The slot 74 is sized in such a way that the anchor 70 is allowed to move laterally in the slot 74 while constraining movement of the anchor 70 perpendicularly to the second major surface 60 of the glass substrate 52. That is, the anchor 70 is configured to move with at least one degree of freedom relative to the frame 54 in response to thermal dimensional changes of at least one of the frame 54 and the glass substrate 62 while limiting the ability of or preventing the glass substrate 52 from moving in a direction away from the frame 54. Providing for lateral movement of the anchor 70 allows for the relative motion between the glass substrate 52 and frame 54 during thermal expansion and contraction. The constraint on the perpendicular movement of the anchor 70 prevents the first adhesive 56 from experiencing tensile stress sufficient to overcome the strength of the first adhesive 56.

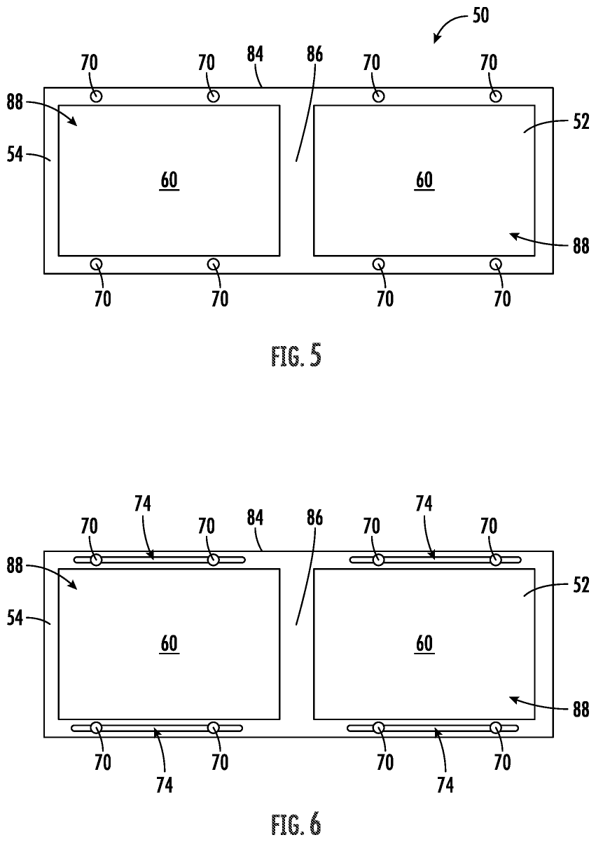

In the embodiment shown in FIG. 4, the slot 74 has a first width W1, the first portion 76 has a second width W2, the intermediate portion 80 has a third width W3, and the second portion 78 has a fourth width W4. As shown in FIG. 4, the widths W1, W2, W3, W4 are measured parallel to the second major surface 60 of the glass substrate 52 in the direction of curvature (i.e., in the direction of the first end 66 to the second end 68). However, in one or more embodiments, the relevant width measurement may be parallel to the second major surface but in a direction transverse to the curvature (such as for the elongated slot 74 shown in FIG. 6).

The second width W2 and the third width W3 are less than the first width W1 to allow the anchor 70 to be inserted through the slot 74. The fourth width W4 is greater than the first width W1 such that the second portion 78 is not able to pass into the slot 74, causing the second portion 78 to abut the rear frame surface 72 upon insertion of the anchor 70 into the slot 74. In one or more embodiments, the second width W2 is greater than the third width W3 to provide a larger bonding area for the first portion 76 against the glass substrate 52. However, in one or more other embodiments, the second width W2 is equal to the third width W3 such that the first portion 76 and the intermediate portion 80 essentially define a post extending from the second portion 78.

As shown in FIG. 4, the first portion 76 of the anchor 70 is attached to the glass substrate 52 using a second adhesive 82. In one or more embodiments, the second adhesive 82 is selected to provide a strong bond between the anchor 70 and the glass substrate 52. As discussed above, the first adhesive 56 is selected, in part, to have some flexibility to withstand the shear forces caused by differential thermal expansion between the glass substrate 52 and frame 54. The bonding area between the first portion 76 and the glass substrate 52 is small enough that thermally-induced stresses are not an issue between the glass substrate 52 and anchor 70. Notwithstanding, the second adhesive 82 may also be selected to exhibit flexibility, and the first adhesive 56 may be selected to exhibit enhanced rigidity depending on the particular needs and geometry of the glass article 50.

In one or more embodiments, the second adhesive 82 is selected to have a higher Young's modulus than the first adhesive 56. However, in one or more other embodiments, the second adhesive 82 may have the same Young's modulus or a lower Young's modulus than the first adhesive 56. For example, the first adhesive 56 can be a pressure sensitive adhesive tape (relatively low Young's modulus), and the second adhesive 82 can be an epoxy (relatively high Young's modulus). In another example, both the first adhesive 56 and the second adhesive 82 can be pressure sensitive adhesive tape or epoxy. In one or more embodiments, the first adhesive 56 has a Young's modulus in a range of 0.5 MPa to 200 MPa. In one or more embodiments, the second adhesive 82 has a Young's modulus in a range of 0.5 MPa to 5 GPa. In general, a lower Young's modulus corresponds to more compliance in the adhesive, meaning that the adhesive is less stiff, as compared to an adhesive with a higher Young's modulus. Further, in general, adhesives with a higher Young's modulus tend to be liquid adhesives providing quicker bonding times and higher stiffness compared to adhesives with lower Young's modulus.

In one or more embodiments, the second adhesive 82 has a thickness between the first portion 76 and the glass substrate 52 of 0.1 mm to 2 mm. In one or more embodiments, the first adhesive 56 has a thickness between the glass substrate 52 and frame 54 of 0.1 mm to 2 mm. In one or more embodiments, the first adhesive 56 has a thickness greater than the thickness of the second adhesive 82. In such embodiments, the thicker first adhesive 56 allows for more compliance between the glass substrate 52 and the frame 54 to accommodate differences in thermal expansion and contraction between the glass substrate 52 and the frame 54. Further, in such embodiments, the thinner second adhesive 82 may correspond to a more rigid bond between the anchor 70 and the glass substrate 52 that limits or prevents relative movement between the anchor 70 and the glass substrate 52. Notwithstanding, different sections of the glass article 50 may include regions wherein the first adhesive 56 has a higher Young's modulus and/or lower thickness than the second adhesive 82. In one or more embodiments, the glass substrate 52 is attached to the frame 54 with the first adhesive 56 and the anchor 70 is attached to the glass substrate 52 with the second adhesive 82 without the use of a primer.

FIG. 5 depicts an embodiment of a glass article 50 as viewed from the rear frame surface 72. In one or more embodiments, the frame 54 of the glass article 50 defines a border 84 around the perimeter of the glass substrate 52. In one or more such embodiments, the anchors 70 and corresponding slots 74 (not visible beneath the anchors 70) are positioned around the border 84 of the frame 54. As shown in the embodiment of FIG. 5, anchors 70 and slots 74 are positioned on longitudinal sides of the border 84 of the frame 54; however, in one or more other embodiments, the anchors 70 and slots 74 may alternatively or additionally be positioned along lateral sides of the border 84 of the frame 54.

In one or more embodiments, the frame 54 includes a pillar 86 extending between two opposing sides of the border 84. As shown in the embodiment of FIG. 5, the pillar 86 extends between opposing longitudinal sides of the border 84; however, in one or more other embodiments, the pillar 86 may alternatively or additionally extend between opposing lateral sides of the border 84. In one or more embodiments, the anchors 70 and slots 74 may also be positioned along the pillar 86.

In one or more embodiments, the frame 54, including the border 84 and pillar 86 (if present), defines one or more openings 88. In one or more embodiments, the openings 88 is configured to accommodate a display module, such as a light-emitting diode (LED) display, an organic LED (OLED) display, a micro-LED display, a liquid crystal display (LCD), or a plasma display, among other possibilities. In one or more embodiments, the display module is attached to the second major surface 60 of the glass substrate 52 (e.g., using a third adhesive, such as an optically clear adhesive). In one or more embodiments, the frame 54 does not have any openings 88 and is a solid backer piece. In such embodiments, a display module can be disposed between the glass substrate 52 and the frame 54.

FIG. 6 depicts another embodiment of the frame 54. In one or more embodiments, the frame 54 includes at least one elongated slot 74 formed in the border 84. A plurality of anchors 70 may be inserted through the elongated slot 74. In this way, the anchor 70 is able to move laterally in response to thermal expansion and contraction of the glass substrate 52 and frame 54 while remaining constrained against movement in a direction perpendicular to the glass substrate 52. In the embodiment depicted in FIG. 6, the elongated slots 74 are formed on longitudinal sides of the border 84, but in one or more other embodiments, the elongated slots 74 may alternatively or additionally be formed along the lateral sides and/or along the pillar 86 (if present).

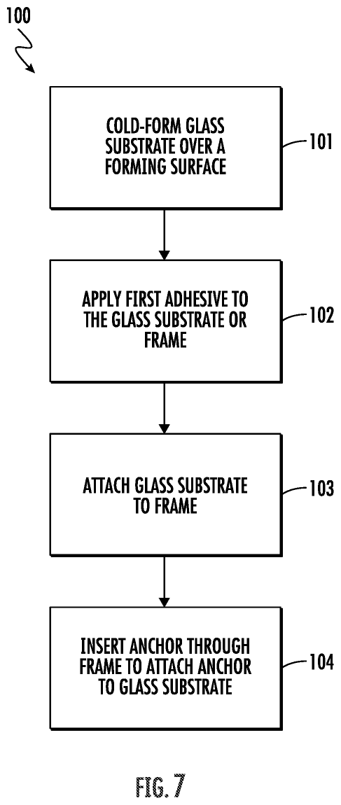

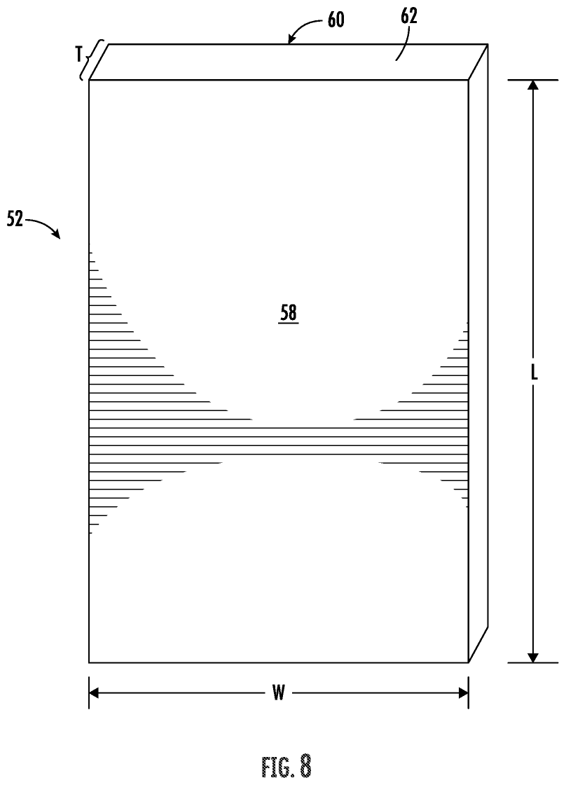

FIG. 7 depicts a flow diagram of a method 100 for forming a glass article 50 according to the present disclosure. In the method 100, a first step 101 involves cold-forming (or elastically bending) the glass substrate 52 over a forming surface, such as a chuck. For example, in one or more embodiments, the glass substrate 52 is bent over a vacuum chuck at a temperature below the softening point of the glass material of the glass substrate (e.g., 200° C. or less, in particular 100° C. or less, and most particularly at or about room temperature). Vacuum is drawn through the chuck to hold the glass substrate 52 in the cold-formed configuration. In one or more embodiments, the forming surface may define a concave curvature so that the first major surface 58 of the glass substrate 52 defines a convex curvature when elastically deformed against the forming surface.

Thereafter, in a second step 102, the first adhesive 56 is applied to one or both of the second major surface 60 of the glass substrate 52 and the curved frame surface 64 of the frame 54. In a third step 103, the frame 54 is pressed to the glass substrate 52 to attach the frame 54 to the glass substrate 52. The first adhesive 56 is allowed to cure, which may happen in ambient conditions or which may be facilitated using, e.g., UV, moisture, or heat. In a fourth step 104, the anchor 70 is inserted through the frame 54 and attached to the glass substrate 52 to form the glass article 50, which is then removed from the forming surface.

During performance of the method, other steps may be involved. For example, the method may involve attaching one or more display modules to the glass substrate 52 and/or frame 54. In one or more embodiments, a display module is attached to the glass substrate 52 prior to cold-forming such that the glass substrate 52 and display module are cold-formed together. In one or more embodiments, the display module is attached to the glass substrate 52 after cold-forming. In either case, the display module may be attached to the glass substrate 52 using an optically clear adhesive. Further, the method may involve applying surface treatments to the glass substrate 52, in particular prior to the step of cold-forming.

In the following paragraphs, various geometrical, mechanical, and strengthening properties of the glass substrate 52 as well as compositions of the glass substrate are provided. Referring to FIG. 8, additional structural details of glass substrate 52 are shown and described. As noted above, glass substrate 52 has a thickness T that is substantially constant and is defined as a distance between the first major surface 58 and the second major surface 60. In various embodiments, T may refer to an average thickness or a maximum thickness of the glass substrate. In addition, glass substrate 52 includes a width W defined as a first maximum dimension of one of the first or second major surfaces 58, 60 orthogonal to the thickness T, and a length L defined as a second maximum dimension of one of the first or second major surfaces 58, 60 orthogonal to both the thickness and the width. In other embodiments, W and L may be the average width and the average length of glass substrate 52, respectively.

In various embodiments, average or maximum thickness T is in the range of 0.3 mm to 2 mm. In various embodiments, width W is in a range from 5 cm to 250 cm, and length L is in a range from about 5 cm to about 1500 cm. As mentioned above, the radius of curvature of the convexly curved glass substrate 52 is about 200 mm to about 10,000 mm.

In embodiments, the glass substrate 52 may be strengthened. In one or more embodiments, glass substrate 52 may be strengthened to include compressive stress that extends from a surface to a depth of compression (DOC). The compressive stress regions are balanced by a central portion exhibiting a tensile stress. At the DOC, the stress crosses from a positive (compressive) stress to a negative (tensile) stress.

In various embodiments, glass substrate 52 may be strengthened mechanically by utilizing a mismatch of the coefficient of thermal expansion between portions of the article to create a compressive stress region and a central region exhibiting a tensile stress. In some embodiments, the glass substrate may be strengthened thermally by heating the glass to a temperature above the glass transition point and then rapidly quenching.

In various embodiments, glass substrate 52 may be chemically strengthened by ion exchange. In the ion exchange process, ions at or near the surface of the glass substrate are replaced by—or exchanged with—larger ions having the same valence or oxidation state. In those embodiments in which the glass substrate comprises an alkali aluminosilicate glass, ions in the surface layer of the article and the larger ions are monovalent alkali metal cations, such as Li⁺, Na⁺, K⁺, Rb⁺, and Cs⁺. Alternatively, monovalent cations in the surface layer may be replaced with monovalent cations other than alkali metal cations, such as Ag⁺ or the like. In such embodiments, the monovalent ions (or cations) exchanged into the glass substrate generate a stress.

Ion exchange processes are typically carried out by immersing a glass substrate in a molten salt bath (or two or more molten salt baths) containing the larger ions to be exchanged with the smaller ions in the glass substrate. It should be noted that aqueous salt baths may also be utilized. In addition, the composition of the bath(s) may include more than one type of larger ions (e.g., Na+ and K+) or a single larger ion. It will be appreciated by those skilled in the art that parameters for the ion exchange process, including, but not limited to, bath composition and temperature, immersion time, the number of immersions of the glass substrate in a salt bath (or baths), use of multiple salt baths, additional steps such as annealing, washing, and the like, are generally determined by the composition of the glass substrate (including the structure of the article and any crystalline phases present) and the desired DOC and CS of the glass substrate that results from strengthening. Exemplary molten bath compositions may include nitrates, sulfates, and chlorides of the larger alkali metal ion. Typical nitrates include KNO₃, NaNO₃, LiNO₃, NaSO₄ and combinations thereof. The temperature of the molten salt bath typically is in a range from about 380° C. up to about 450° C., while immersion times range from about 15 minutes up to about 100 hours depending on glass substrate thickness, bath temperature and glass (or monovalent ion) diffusivity. However, temperatures and immersion times different from those described above may also be used.

In one or more embodiments, the glass substrate 52 may be immersed in a molten salt bath of 100% NaNO₃, 100% KNO₃, or a combination of NaNO₃ and KNO₃ having a temperature from about 370° C. to about 480° C. In some embodiments, the glass substrate may be immersed in a molten mixed salt bath including from about 5% to about 90% KNO₃ and from about 10% to about 95% NaNO₃. In one or more embodiments, the glass substrate may be immersed in a second bath, after immersion in a first bath. The first and second baths may have different compositions and/or temperatures from one another. The immersion times in the first and second baths may vary. For example, immersion in the first bath may be longer than the immersion in the second bath.

In one or more embodiments, the glass substrate may be immersed in a molten, mixed salt bath including NaNO₃ and KNO₃ (e.g., 49%/51%, 50%/50%, 51%/49%) having a temperature less than about 420° C. (e.g., about 400° C. or about 380° C.). for less than about 5 hours, or even about 4 hours or less.

Ion exchange conditions can be tailored to provide a “spike” or to increase the slope of the stress profile at or near the surface of the resulting glass substrate. The spike may result in a greater surface CS value. This spike can be achieved by a single bath or multiple baths, with the bath(s) having a single composition or mixed composition, due to the unique properties of the glass compositions used in the glass substrates described herein.

In one or more embodiments, where more than one monovalent ion is exchanged into the glass substrate, the different monovalent ions may exchange to different depths within the glass substrate (and generate different magnitudes stresses within the glass substrate at different depths). The resulting relative depths of the stress-generating ions can be determined and cause different characteristics of the stress profile.

CS is measured using those means known in the art, such as by surface stress meter (FSM) using commercially available instruments such as the FSM-6000, manufactured by Orihara Industrial Co., Ltd. (Japan). Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM standard C770-98 (2013), entitled “Standard Test Method for Measurement of Glass Stress-Optical Coefficient,” the contents of which are incorporated herein by reference in their entirety, and a bulk cylinder method. As used herein CS may be the “maximum compressive stress” which is the highest compressive stress value measured within the compressive stress layer. In some embodiments, the maximum compressive stress is located at the surface of the glass substrate. In other embodiments, the maximum compressive stress may occur at a depth below the surface, giving the compressive profile the appearance of a “buried peak.”

DOC may be measured by FSM or by a scattered light polariscope (SCALP) (such as the SCALP-04 scattered light polariscope available from GlasStress Ltd., located in Tallinn Estonia), depending on the strengthening method and conditions. When the glass substrate is chemically strengthened by an ion exchange treatment, FSM or SCALP may be used depending on which ion is exchanged into the glass substrate. Where the stress in the glass substrate is generated by exchanging potassium ions into the glass substrate, FSM is used to measure DOC. Where the stress is generated by exchanging sodium ions into the glass substrate, SCALP is used to measure DOC. Where the stress in the glass substrate is generated by exchanging both potassium and sodium ions into the glass, the DOC is measured by SCALP, since it is believed the exchange depth of sodium indicates the DOC and the exchange depth of potassium ions indicates a change in the magnitude of the compressive stress (but not the change in stress from compressive to tensile); the exchange depth of potassium ions in such glass substrates is measured by FSM. Central tension or CT is the maximum tensile stress and is measured by SCALP.

In one or more embodiments, the glass substrate may be strengthened to exhibit a DOC that is described as a fraction of the thickness T of the glass substrate (as described herein). For example, in one or more embodiments, the DOC may be in the range of about 0.05 T to about 0.25 T. In some instances, the DOC may be in the range of about 20 μm to about 300 μm. In one or more embodiments, the strengthened glass substrate 52 may have a CS (which may be found at the surface or a depth within the glass substrate) of about 200 MPa or greater, about 500 MPa or greater, or about 1050 MPa or greater. In one or more embodiments, the strengthened glass substrate may have a maximum tensile stress or central tension (CT) in the range of about 20 MPa to about 100 MPa.

Suitable glass compositions for use as glass substrate 52 include soda lime glass, aluminosilicate glass, borosilicate glass, boroaluminosilicate glass, alkali-containing aluminosilicate glass, alkali-containing borosilicate glass, and alkali-containing boroaluminosilicate glass.

Unless otherwise specified, the glass compositions disclosed herein are described in mole percent (mol %) as analyzed on an oxide basis.

In one or more embodiments, the glass composition may include SiO₂ in an amount in a range from about 66 mol % to about 80 mol %. In one or more embodiments, the glass composition includes Al₂O₃ in an amount of about 3 mol % to about 15 mol %. In one or more embodiments, the glass article is described as an aluminosilicate glass article or including an aluminosilicate glass composition. In such embodiments, the glass composition or article formed therefrom includes SiO₂ and Al₂O₃ and is not a soda lime silicate glass.

In one or more embodiments, the glass composition comprises B₂O₃ in an amount in the range of about 0.01 mol % to about 5 mol %. However, in one or more embodiments, the glass composition is substantially free of B₂O₃. As used herein, the phrase “substantially free” with respect to the components of the composition means that the component is not actively or intentionally added to the composition during initial batching, but may be present as an impurity in an amount less than about 0.001 mol %.

In one or more embodiments, the glass composition optionally comprises P₂O₅ in an amount of about 0.01 mol % to 2 mol %. In one or more embodiments, the glass composition is substantially free of P₂O₅.

In one or more embodiments, the glass composition may include a total amount of R₂O (which is the total amount of alkali metal oxide such as Li₂O, Na₂O, K₂O, Rb₂O, and Cs₂O) that is in a range from about 8 mol % to about 20 mol %. In one or more embodiments, the glass composition may be substantially free of Rb₂O, Cs₂O or both Rb₂O and Cs₂O. In one or more embodiments, the R₂O may include the total amount of Li₂O, Na₂O and K₂O only. In one or more embodiments, the glass composition may comprise at least one alkali metal oxide selected from Li₂O, Na₂O and K₂O, wherein the alkali metal oxide is present in an amount greater than about 8 mol % or greater.

In one or more embodiments, the glass composition comprises Na₂O in an amount in a range from about from about 8 mol % to about 20 mol %. In one or more embodiments, the glass composition includes K₂O in an amount in a range from about 0 mol % to about 4 mol %. In one or more embodiments, the glass composition may be substantially free of K₂O. In one or more embodiments, the glass composition is substantially free of Li₂O. In one or more embodiments, the amount of Na₂O in the composition may be greater than the amount of Li₂O. In some instances, the amount of Na₂O may be greater than the combined amount of Li₂O and K₂O. In one or more alternative embodiments, the amount of Li₂O in the composition may be greater than the amount of Na₂O or the combined amount of Na₂O and K₂O.

In one or more embodiments, the glass composition may include a total amount of RO (which is the total amount of alkaline earth metal oxide such as CaO, MgO, BaO, ZnO and SrO) in a range from about 0 mol % to about 2 mol %. In one or more embodiments, the glass composition includes CaO in an amount less than about 1 mol %. In one or more embodiments, the glass composition is substantially free of CaO. In some embodiments, the glass composition comprises MgO in an amount from about 0 mol % to about 7 mol %.

In one or more embodiments, the glass composition comprises ZrO₂ in an amount equal to or less than about 0.2 mol %. In one or more embodiments, the glass composition comprises SnO₂ in an amount equal to or less than about 0.2 mol %.

In one or more embodiments, the glass composition may include an oxide that imparts a color or tint to the glass articles. In some embodiments, the glass composition includes an oxide that prevents discoloration of the glass article when the glass article is exposed to ultraviolet radiation. Examples of such oxides include, without limitation oxides of: Ti, V, Cr, Mn, Fe, Co, Ni, Cu, Ce, W, and Mo.

In one or more embodiments, the glass composition includes Fe expressed as Fe₂O₃, wherein Fe is present in an amount up to 1 mol %. Where the glass composition includes TiO₂, TiO₂ may be present in an amount of about 5 mol % or less.

An exemplary glass composition includes SiO 2 in an amount in a range from about 65 mol % to about 75 mol %, Al₂O₃ in an amount in a range from about 8 mol % to about 14 mol %, Na₂O in an amount in a range from about 12 mol % to about 17 mol %, K₂O in an amount in a range of about 0 mol % to about 0.2 mol %, and MgO in an amount in a range from about 1.5 mol % to about 6 mol %. Optionally, SnO₂ may be included in the amounts otherwise disclosed herein. It should be understood, that while the preceding glass composition paragraphs express approximate ranges, in other embodiments, glass substrate 52 may be made from any glass composition falling with any one of the exact numerical ranges discussed above.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

1. A glass article, comprising:
a frame having a curved frame surface and a rear frame surface, the curved frame surface defining at least one convex curvature and the rear frame surface being opposite to the curved frame surface;
a glass substrate having a first major surface, a second major surface opposite to the first major surface, a first end, and a second end;
a first adhesive attaching the second major surface of the glass substrate to the curved frame surface such that the glass substrate is elastically deformed and the first major surface defines a convex curvature between the first end and the second end;
a first anchor having a first portion attached to the second major surface of the glass substrate and a second portion abutted against the rear frame surface;
wherein the frame and first anchor are configured such that the first anchor is able to move laterally in the direction of the first end or the second end and such that the first anchor is constrained against movement in a direction perpendicular to the second major surface.

2. The glass article of claim 1, wherein the first portion of the first anchor is attached to the second major surface of the glass substrate with a second adhesive.

3. The glass article of claim 2, wherein the first adhesive comprises a first Young's modulus, wherein the second adhesive comprises a second Young's modulus, and wherein the second Young's modulus is greater than the first Young's modulus.

4. The glass article of claim 2, wherein the first adhesive comprises a first Young's modulus, wherein the second adhesive comprises a second Young's modulus, and wherein the second Young's modulus equal to or less than the first Young's modulus

5. The glass article of claim 1, wherein the frame comprises a second frame surface opposite to the first frame surface, wherein the frame comprises a first slot extending from the first frame surface to the second frame surface, and wherein the first anchor extends through the first slot.

6. The glass article of claim 5, wherein the first slot comprises a first width measured in a direction parallel to the second major surface of the glass substrate, wherein the second portion of the first anchor comprises a second width, and wherein the second width is greater than the first width.

7. The glass article of claim 6, wherein the first anchor comprises an intermediate portion disposed between the first portion and the second portion, wherein the intermediate portion comprises a third width, and wherein the third width is less than the first width.

8. The glass article of claim 1, further comprising a second anchor having a fourth portion attached to the second major surface of the glass substrate and a fifth portion abutted against the frame, wherein the first anchor is positioned nearer to the first end than the second anchor and the second anchor is positioned nearer to the second end than the first anchor.

9. (canceled)

10. (canceled)

11. The glass article of claim 1, wherein a distance between the first major surface and the second major surface defines a thickness of the glass substrate and wherein the thickness is from 0.3 mm to 2 mm.

12. (canceled)

13. (canceled)

14. The glass article of claim 1, wherein the first anchor is not directly attached to the frame with an adhesive or fastener.

15. A method, comprising:
elastically bending a glass substrate over a forming surface at a temperature of less than 200° C., the glass substrate comprising a first major surface, a second major surface opposite to the first major surface, a first end, and a second end;
adhering the second major surface of the glass substrate to a frame using a first adhesive;
attaching a first portion of a first anchor to the second major surface of the glass substrate; and
abutting a second portion of the first anchor against the frame such that the first anchor prevents movement of the second major surface away from the frame, wherein, after the abutting, the first anchor is configured to move with at least one degree of freedom relative to the frame in response to thermal dimensional changes of at least one of the frame and the glass substrate.

16. The method of claim 15, wherein the attaching further comprises adhering the first portion of the first anchor to the second major surface of the glass substrate using a second adhesive.

17. The method of claim 16, wherein the first adhesive comprises a first Young's modulus, wherein the second adhesive comprises a second Young's modulus, and wherein the second Young's modulus is greater than the first Young's modulus.

18. The method of claim 16, wherein the first adhesive comprises a first Young's modulus, wherein the second adhesive comprises a second Young's modulus, and wherein the second Young's modulus is greater than the first Young's modulus

19. The method of claim 15, wherein the frame comprises a curved frame surface and a rear frame surface opposite to the curved frame surface, wherein the frame comprises a first slot extending from the curved frame surface to the rear frame surface, and wherein the method further comprises inserting the anchor through the first slot before the attaching.

20. The method of claim 19, wherein the first slot comprises a first width measured in a direction parallel to the second major surface of the glass substrate, wherein the second portion of the first anchor comprises a second width, and wherein the second width is greater than the first width.

21. The method of claim 20, wherein the first anchor comprises a third portion disposed between the first portion and the second portion, wherein the third portion comprises a third width, and wherein the third width is less than the first width.

22. The method of claim 15, further comprising:
attaching a fourth portion of a second anchor to the second major surface of the glass substrate and abutting a fifth portion of the second anchor against the frame, and
positioning the first anchor nearer to the first end than the second anchor and positioning the second anchor nearer to the second end than the first anchor.

23. (canceled)

24. The method of claim 15, wherein abutting the second portion of the first anchor against the frame does not involve directly attaching the second portion of the first anchor to the frame with an adhesive or fastener.

25. A glass article, comprising:
a frame comprising a convexly curved surface;
a cold-formed glass substrate comprising a first major surface and a second major surface being opposite to the first major surface, the second major surface adhered to the convexly curved surface;
at least one anchor attached to the second major surface of the cold-formed glass substrate;
wherein the at least one anchor engages the frame in such a way as to constrain the cold-formed glass substrate from motion in a direction away from the convexly curved surface.

26. (canceled)

27. (canceled)

28. (canceled)

29. (canceled)

30. (canceled)
